(19) United States
(12) Patent Application Publication
(10) Pub. No.: US 2011/0316927 A1
(43) Pub. Date: Dec. 29, 2011

(54) Ink-Jet Textile Printing/Recording Process

(75) Inventors: Hiroshi Yamashita, Tokyo (JP); Hidenobu Ohya, Tokyo (JP)

(73) Assignee: Konica Minolta IJ Technologies, Inc, Hino-shi, Tokyo (JP)

(21) Appl. No.: 13/254,156

(22) PCT Filed: Jan. 22, 2010
(86) PCT No.: PCT/JP2010/050769

§ 371 Date: Aug. 31, 2011

(30) Foreign Application Priority Data
Mar. 5, 2009 (JP) 2009-051830

(51) Int. Cl. B41J 2/015

(52) U.S. Cl. 347/20

(57) ABSTRACT

Provided is an ink-jet textile printing/recording process, by which it is possible to form high-quality prints which do not suffer from bleeding, lowering in the density of developed color, contamination of non-printed white areas, or other faults. Thus, the ink-jet textile printing/recording process enables the expression of colorful designs. The ink-jet textile printing/recording process comprises applying a functional ink by an ink-jet system to at least portions of a textile where printed areas with the maximum density are to be formed, and then applying a recording ink to the resulting textile by an ink-jet system, wherein the functional ink contains both a water-soluble polymer and a water-soluble organic solvent, and the recording ink contains a disperse dye, a binder resin, and a water-soluble organic solvent.

### FIELD OF THE INVENTION

The present invention relates to an ink-jet textile printing/recording process which comprises applying a functional ink before printing by using a recording ink so as to form high-quality prints and the expression of colorful designs.

### TECHNICAL BACKGROUND

An ink-jet printing technology is extensively used today as the on-demand printing technology which can directly print on a various substrate based on a digital image data. In an ink-jet printing field, a number of printing apparatus are put to practical use which prints on textiles by ink-jet process. However, when prints are formed directly on textiles by ink-jet process, there remains much needs to be improved in suffering from bleeding or lowering in the density of developed color.

So as to improve the final print quality, a special treatment (referred to as pre-treatment process) is conventionally provided on a textile and then ink-jet print was carried out. According to this process, numbers of steps increase and performances such as delivering in a short time in small lots which are advantages of digital ink-jet printing method cannot be exerted enough. Further, when the pre-treated textiles are stored in a long period, it tends to cause a color change.

Further, desired are applying various complex processes so as to express colorful designs by taking advantage of digital printing. However, by the apparatus used for the conventional ink-jet printing, satisfactory quality cannot be available as it now stands.

In order to enhance the print quality and to apply the expression of colorful designs as well as the print-on-demand performance of the ink-jet printing method, examined was a method for inhibiting bleeding in which a functional liquid other than a recording ink was prepared and was applied in the sequential step after applying the recording ink (for example, referred to Patent Document 1). Further, examined was a method in which a recording ink (dispersed dye ink) comprises a polymer resin and a water-soluble solvent and a pre-treatment process is neglected (for example, referred to Patent Document 2).

In Patent Document 1, disclosed is a method in which an image is rimmed with the first ink containing an inhibitor of bleeding. As the inhibitor of bleeding, disclosed is an addition of a hydrophobic compound having a water-shedding property, whereby this invention is a method aimed for preventing the bleeding at a boundary between white background and image or a boundary between areas of different specific color phases. However, this method is not employable for inhibiting the bleeding of the print image which has rich expressive power by a gradation expression. Further, this method is hardly adequate for an expression of fine lines or detailed image. Namely, even though the position of the print area of the first ink and the print image by color ink has to be precisely adjusted, since textile itself tends to be elongated and contracted, it is extremely difficult to achieve this position adjustment. Further, since the first ink itself bleeds into the textile, it is principally difficult to draw extremely fine lines.

In view of the foregoing method, the inventors of the present invention conducted diligent investigations about methods for inhibiting bleeding by sequentially applying a functional liquid and a recording ink. As a result, the following problems were found: since a concentration of a bleeding inhibitor was limited for applying a functional liquid stably and resulting in increasing a total liquid applied on the textile, whereby bleeding became worse or print quality was deteriorated such as lowering in the density of developed color. Further, found was a trouble such that, in a washing step after dying step, a part of a dye was eluted out to washing water and resulted in causing a contamination by dying an un-dyed portion (white background).

On the contrary, in the method disclosed in Patent Document 2, disclosed was an ink having carboxyl group or sulfonate group as acid group, containing a polymer resin having acid value of not less than 80 mg KOH/g and not more than 300 mg KOH/g, and in an amount of not less than 2% by mass and not more than 10% by mass in terms of solids, whereby the pre-treatment step was eliminated. However, in the case of using thin textile, an inhibition effect on bleeding or contamination on a white background was not sufficient and it was difficult to use without limitation to the textile species.

### PRIOR TECHNICAL DOCUMENT

### Patent Document

Patent Document 1: Unexamined Japanese Patent Application Publication (hereinafter referred to as JP-A) No. 9-296380

Patent Document 2: JP-A No. 2008-291079

### SUMMARY

### Problems to be Solved by the Present Invention

In view of the foregoing, the present invention was achieved. An object of the present invention is to provide an ink-jet printing/recording process which enables the expression of colorful designs by enhancing the print finality without bleeding or lowering in the density of developed color and contamination on a white background.

### Means to Solve the Problems

The above object has been attained by the following constitutions:
1. An ink-jet textile printing/recording process comprising steps of applying a functional ink by an ink-jet system to at least a portion of a textile where printed area with the maximum density is to be formed, and followed by applying a recording ink to the resulting textile by an ink-jet system, wherein the functional ink comprises a water-soluble polymer and a water-soluble organic solvent, and the recording ink comprises a disperse dye, a binder resin, and a water-soluble organic solvent
2. The ink-jet textile printing/recording process of item 1, wherein the water-soluble high-molecular compound is at least one selected from a group of polyvinyl pyrrolidone, polyethylene glycol, ethylene oxide-propylene oxide copolymer, polyethylene oxide adduct of glycerin, polypropylene adduct of glycerin, polyethylene oxide adduct of diglycerin, polypropylene adduct of diglycerin, and acrylic resin.
3. The ink-jet textile printing/recording process of item 1, wherein the water-soluble high-molecular compound is at least one selected from a group of polyvinyl pyrrolidone and ethylene oxide-propylene oxide copolymer.
4. The ink-jet textile printing/recording process of any one of items 1 to 3, wherein the binder resin has a carboxyl group, an acid value of the binder resin of not less than 100 mg KOH/g and not more than 300 mg KOH/g, and a weight-average molecular weight of not less than 3,000 and not more than 30,000.
5. The ink-jet textile minting/recording process of any one of items 1 to 4, wherein the textile is not treated with a pre-treatment, and a sum of an applied amount of the water-soluble polymer applied by the functional ink and an amount of the resin binder applied by the recording ink is not less than 0.5 g/m² and not more than 5.0 g/m² at a portion of the textile where printed area with the maximum density is to be formed by single color.
6. The ink-jet textile printing/recording process of any one of items 1 to 5, wherein at least one of the water-soluble organic solvent in the functional ink is glycol ethers or 1,2-alkane diols.
7. The ink-jet textile printing/recording process of any one of items 1 to 6, wherein the disperse dye in the recording ink is dispersed by a lignin sulfonates.
8. The ink-jet textile printing/recording process of any one of items 1 to 7, comprising a step of heating the textile to a surface temperature in the range of 35° C. to 70° C. at a portion where the recording ink is applied.
9. The ink-jet textile printing/recording process of any one of items 1 to 8, comprising a step of drying between the step of applying the functional ink and the step of applying the recording ink.

### Effects of the Invention

The present invention can provide an ink-jet printing/recording process which enables the expression of colorful designs by enhancing the print quality without bleeding or lowering in the density of developed color and contamination on a white background.

### BRIEF DESCRIPTION OF THE DRAWING

FIG. 1 is a schematic diagram of the printer for evaluation of the present invention.

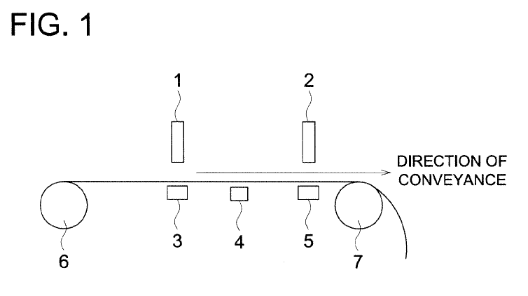

### PREFERRED EMBODIMENT OF THE INVENTION

The present invention will now be detailed.

In view of the foregoing, the inventors of the present invention conducted diligent investigations. As a result, the following was discovered.

Namely, immediately after the functional ink is applied or before the functional ink is dried, the sum of applied liquid increases and reaches to or exceeds the amount of the ink absorptive capacity of the textile, thereby causes bleeding or a contamination on the apparatus. Therefore, these object described above can be resolved by applying the minimum need to the functional ink and by incorporating the binder resin and the water-soluble organic solvent in the recording ink.

The ink-jet printing/recording process of the present invention will now be further detailed.

### <<Functional Ink>>

The constitution of the functional ink according to the present invention will now be detailed.

In the ink-jet printing/recording process of the present invention, the functional ink is utilizes in order to enhance a print quality. The functional ink comprises the water-soluble polymer which has a solubility of 1% by mass or more based on water or alkali aqueous solution at 25° C. and the water-soluble organic solvent which can be miscible with water in 1% by mass or more.

### [Water-soluble Polymer]

In view of inhibiting a bleeding by the recording ink, a lowering in the density of developed color and a contamination on a white background, the functional ink of the present invention comprises the water-soluble polymer.

As the water-soluble polymer applied for the functional ink of the present invention, preferred is a polymer having a hydroxyl group value of less than 50 mg KOH/g, a weight-average molecular weight of not less than 1,000 and not more than 100,000 and a solubility of 10% by mass or more based on water or alkali aqueous solution at 25° C.

The water-soluble polymer of the present invention is preferable at least one selected from a group of polyvinyl pyrrolidone, polyethylene glycol, ethylene oxide-propylene oxide copolymer, polyethylene oxide adduct of glycerin, polypropylene adduct of glycerin, polyethylene oxide adduct of diglycerin, polypropylene adduct of diglycerin, and acrylic resin.

Polyvinylpyrrolidone is classified by a viscosity property relating to a molecular weight. K (Kollidon) 15, K30 and K60 (manufactured by Tokyo Chemical Industry Co., Ltd.) are preferably employed. Of these, K15 and K30 are preferable in view of the stable ink-jet ejection and the effect of inhibiting bleeding. Content in the functional ink is preferably from 2% by mass to 20% by mass in terms of solids.

Polyethylene glycol having an average molecular weight of 600 or more is preferably employed. Further, polyethylene glycol having an average molecular weight of 1000 or more and 4000 or less is more preferably employed, in view of the effect of inhibiting bleeding. Content in the functional ink is preferably from 2% by mass to 20% by mass.

Ethylene oxide-propylene oxide copolymer includes a compound having a structure in which polyethylene oxide is added to a terminal of polypropylene glycol, polypropylene oxide is added to a terminal of polyethylene glycol, and random copolymer of ethyleneoxide-propyleneoxide.

As a compound having a structure in which polyethylene oxide is added to a terminal of polypropylene glycol, compounds having various mixing ratio of ethyleneoxide-propyleneoxide and various molecular weights are available in the market from ADEKA Pluronic L, P, F Series produced by ADEKA CORPORATION, and can be selected from thereof. Specifically, a compound having a molecular weight of polypropylene group 2000 or less and water-soluble is preferably employed, as listed L-62, L-64, F-68, F-88, F-108, L-44, L-34, and L-23.

As a compound having a structure in which polypropylene oxide is added to a terminal of polyethylene glycol can be employed by selecting from Reverse type, 17R-2, 17R-3, and 17R-4 produced by ADEKA CORPORATION.

Content of ethylene oxide-propylene oxide copolymer in the functional ink is preferably from 2% by mass to 20% by mass.

Polyethylene oxide adduct of diglycerin can be employed by selecting from SC-E serried produced by Sakamoto Yakuhin Kogyo Co., Ltd. SC-E450, SC-E750, SC-E1000 and SC-E1500 are preferably employable. Content in the functional ink is preferably from 2% by mass to 20% by mass.

Polypropylene oxide adduct of diglycerin can be employed by selecting from SC-P serried produced by Sakamoto Yakuhin Kogyo Co., Ltd. SC-P400, SC-P750, and SC-P1000 are preferably employable. Content in the functional ink is preferably from 2% by mass to 20% by mass.

When a content of water-soluble polymer in the functional ink is less than the lower limit of the preferable range above, it tends to be difficult to inhibit bleeding enough. When the content in the functional ink is more than the upper limit, it tends to be difficult in uniform application, specifically in application by ink-jet due to unstable ejection. Therefore, both cases are undesirable.

These water-soluble polymers can be used individually or in combinations of a plurality of types.

### [pH Controlling Agents]

In the functional ink of the present invention, pH controlling agents may be preferably incorporated in the ink so as to keep a storage stability of the ink.

Examples the pH controlling agents include organic and inorganic acids. As the inorganic acids, listed may be, for example, hydrochloric acid, sulfuric acid, chlorous acid, nitric acid, nitrous acid, sulfurous acid, phosphorous acid, phosphoric acid, chloric acid, and hypophosphorous acid. As the organic acids, listed may be, for example, formic acid, acetic acid, propionic acid, butyric acid, isobutyric acid, valeric acid, isovaleric acid, oxalic acid, malonic acid, succinic acid, glutaric acid, maleic acid, fumaric acid, citraconic acid, itaconic acid, tricarballylic acid, glycolic acid, thioglycolic acid, lactic acid, malic acid, tartaric acid, citric acid, isocitric acid, gluconic acid, pyruvic acid, oxalacetic acid, diglycol acid, benzoic acid,phthalic acid, mandelic acid, and salicylic acid. Of these, preferred is at least one selected from tartaric acid, citric acid and lactic acid.

Content of pH controlling agents is preferably not less than 0.1 mol equivalent/L and not more than 1 mol equivalent/L.

### [Solid Humectant]

In the functional ink of the present invention, a solid humectant is preferably employed in view of inhibiting unstable ejection due to drying the ink at ink-jet head. As solid humectant, listed are water-soluble amides, sulfonamides, urea, and urea derivatives. Content of solid humectant in the functional ink is preferably not less than 2% by mass and less than 40% by mass.

### [Water-Soluble Solvent]

The functional ink of the present invention contains a water-soluble organic solvent, in view of inhibiting a bleeding by the recording ink and a contamination on a white background.

Specific examples of water-soluble organic solvent include: alcohols (such as methanol, ethanol, propanol, isopropanol, butanol, isobutanol, secondary butanol, and tertiary butanol); polyhydric alcohols (such as ethylene glycol, diethylene glycol, Methylene glycol, polyethylene glycol, propylene glycol, dipropylene glycol, polypropylene glycol, butylene glycol, hexanediol, pentanediol, glycerine, hexanetriol and thiodiglycol); amines (such as ethanolamine, diethanol amine, triethanolamine, N-methyldiethanol amine, N-ethyldiethanolamine, morpholine, N-ethylmorpholine, ethylenediamine, diethylenediamine, triethylenetetramine, tetraethylenepentamine, polyethyleneimine, pentamethyldiethylenetriamine and tetramethylpropylenediamine); amides (such as formamide, N,N-dimethylformamide and N,N-dimethylacetoamide); heterocyclic compounds (such as 2-pyrrolidone, N-methyl-2-pyrrolidone, cyclohexyl pyrrolidone, 2-oxazolidone and 1,3-dimethyl-2-imidazolidinone); and sulfoxides (such as dimethylsuofoxide). The same compound may combine a water-soluble polymer with a water-soluble organic solvent.

In order to exhibit more remarkable effect of the present invention, at least one of the water-soluble organic solvent is preferably glycol ethers or 1,2-alkanediols, which promotes penetration of the recording ink into the textile, resulting in the effect of dying backside or the base of thick pile of the raised textile. Preferably employable are listed below:

Glycol ether includes such as ethyleneglyeol monoethyl ether, ethyleneglycol monobutyl ether, diethyleneglycol monoethyl ether, diethyleneglycol monobutyl ether, triethyleneglycol monobutyl ether, propyleneglycol monopropyl ether, dipropyleneglycol monomethyl ether and tripropyleneglycol monobutyl ether.

Further, 1,2-alkanediols include 1,2-butanediol, 1,2-pentanediol, 1,2-hexanediol and 1,2-heptanediol.

These water-soluble organic solvent may be added for the purpose of adjusting a surface tension or viscosity of the functional ink. Content is preferably 1-80% by mass and a plurality of water-soluble organic solvent may be added.

### [Physical Property of Functional Ink]

The physical property of the functional ink may be adjusted according to the textiles. Viscosity is preferable not less than 3 mPa·s and less than 20 mPa·s. Surface tension is preferable not less than 20 mN/m and not more than 70 mN/m.

In the case of enhancing developed color at the surface by locating the functional ink at the surface of the textile, it is preferable to be not less than 5 mPa·s and less than 20 mPa·s in viscosity and not less than 35 mN/m and less than 70 mN/m in surface tension. In the case of penetrating the functional ink deeply into the textile, it is preferable to be not less than 3 mPa·s and less than 12 mPa·s in viscosity and not less than 20 mN/m and less than 35 mN/m in surface tension.

### [Surface Active Agent]

According to using the functional ink of the present invention, various kinds of surface active agents may be utilized in the case of penetrating the dye in the recording ink deeply into the textile.

The surface active agent usable in the present invention is not particularly limited. Specific examples include: anionic surface active agents such as dialkylsulfosuccinates, alkylnaphthalene sufonates and fatty acid salts; nonionic surface active agents such as polyoxyethylene alkylethers, polyoxyethylene allcylarylethers, acetyleneglycols, and polyoxyethylene-polyoxypropylene block copolymers; and cationic surface active agents such as alkylamines, and tertiary ammonium salts. Of these, anionic surface active agents and nonionic surface active agents are preferably utilized.

In order to penetrate the dye in the recording ink deeply into the textile, surface tension viscosity of the functional ink is preferably controlled to be not less than 20 mN/m and not more than 35 mN/m. Specifically, it is preferable to control the surface tension by adding silicone type or fluorine type surface active agent.

### <Silicone Type Surface Active Agent or Fluorine Type Surface Active Agent>

A silicone type surface active agent is preferably a polyether modified polysiloxane compound and includes such as KF-351A and KF-642 which are produced by Shin-Etsu Chemical Co., Ltd., and BY345, BY347 and BYK348 which are produced by BYK-Chemie GmbH.

A fluorine type surface active agent means general surface active agents in which a part of or the total of hydrogen bondings to carbon of a hydrophobic group is substituted by fluorine. Of these, those having a perfluoroalkyl group in a molecule are preferred.

Certain types among fluorine type surface active agents are each available on the market under a product name of Megafac F from Dainippon Ink & Chemicals, Inc., Surflon from Asahi Glass Co., Ltd., Fluorad FC from Minnesota Mining and Manufacturing Company, Monflor from Imperial Chemical Industries, Zonyls from E. I. du Pont de Numours and Company, Licowet VPF from Hoechst AG, and Ftergent from Neos Corp.

Further, a nonionic fluorine type surface active agent includes, for example, Megafax 144D produced by Dainippon Ink & Chemicals, Inc., Surflon S-141 and Surflon 5-145 produced by Asahi Glass Co., Ltd. and Ftergent 251 produced by Neos Co., Ltd. Further, an ampholytic fluorine type surface active agent includes, for example, Surflon S-131 and Surflon S-132 produced by Asahi Glass Co., Ltd.

### <<Recording Ink>>

The constitution of the recording ink according to the present invention will now be detailed.

The recording ink of the present invention is characterized by containing a disperse dye, a binder resin, and a water-soluble organic solvent

### [Disperse Dye]

The disperse dye of the present invention is preferable to be a dye having poorly-water-soluble, a chemical structure such as azo type, anthraquinone type or other condensation type, relatively small molecular weight, and without having water-soluble group. In the present invention, known disperse dye is preferred which satisfies above conditions.

Disperse dye preferably utilized in this invention includes such as

C.I. Disperse Yellow 3, 4, 5, 7, 9, 13, 24, 30, 33, 34, 42, 44, 49, 50, 51, 54, 56, 58, 60, 63, 64, 66, 68, 71, 74, 76, 79, 82, 83, 85, 86, 88, 90, 91, 93, 98, 99, 100, 104, 114, 116, 118, 119, 122, 124, 126, 135, 140, 141, 149, 160, 162, 163, 164, 165, 179, 180, 182, 183, 186, 192, 198, 199, 202, 204, 210, 211, 215, 216, 218, 224;

C.I. Disperse Orange 1, 3, 5, 7, 11, 13, 17, 20, 21, 25, 29, 30, 31, 32, 33, 37, 38, 42, 43, 44, 45, 47, 48, 49, 50, 53, 54, 55, 56, 57, 58, 59, 61, 66, 71, 73, 76, 78, 80, 89, 90, 91, 93, 96, 97, 119, 127, 130, 139, 142;

C.I. Disperse Red 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, 328;

C.I. Disperse Violet 1, 4, 8, 23, 26, 27, 28, 31, 33, 35, 36, 38, 40, 43, 46, 48, 50, 51, 52, 56, 57, 59, 61, 63, 69, 77;

C.I. Disperse Green 9;

C.I. Disperse Brown 1, 2, 4, 9, 13, 19;

C.I. Disperse Blue 3, 7, 9, 14, 16, 19, 20, 26, 27, 35, 43, 44, 54, 55, 56, 58, 60, 62, 64, 71, 72, 73, 75, 79, 81, 82, 83, 87, 91, 93, 94, 95, 96, 102, 106, 108, 112, 113, 115, 118, 120, 122, 125, 128, 130, 139, 141, 142, 143, 146, 148, 149, 153, 154, 158, 165, 167, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, 333; and

C.I. Disperse Black 1, 3, 10, 24.

It is possible to prepare the ink according to the present invention by blending dispersing agents, humectants, media, and optional additives together with water-insoluble disperse dyes and dispersing the resulting mixture employing a homogenizer. Employed as homogenizers may be a ball mill, a sand mill, a line mill, or a high pressure homogenizer, which are conventionally used in the prior art.

The average diameter of disperse dye particles is preferably at most 300 nm and the maximum particle diameter is preferably at most 900 nm. When the average particle diameter and maximum particle diameter each exceed the above range, in an ink-jet textile printing/recording process in which ejection is conducted from minute nozzles, clogging tends to occur, whereby it is not possible to perform stable ejection. Incidentally, it is possible to determine the average particle diameter employing commercially available particle size measurement instruments employing a light scattering method, an electrophoretic method, or a laser Doppler method. Listed as a specific particle size measurement instrument may, for example, be ZETER SIZER 1000, produced by Malvern Inc.

The content of disperse dyes in the recording ink according to the present invention is not particularly limited and is preferably not less than 0.1% by mass and less than 20% by mass, but is more preferably not less than 0.2% by mass and less than 13% by mass. It is possible to employ commercially available disperse dyes without any treatment, but it is preferable to employ them after subjecting them to a purification treatment. Employed as such a purification method may be a recrystallization method and a washing method known in the prior art. It is preferable that suitable organic solvents employed for the purification method and purification treatment are selected depending on the type of dyes.

### [Dispersing Agent]

Listed as dispersing agents usable in the ink according to the present invention may be polymer dispersing agents and low molecular weight surface active agents. Of these, in view of storage stability of the ink, it is preferable to use polymer dispersing agents.

Listed as polymer dispersing agents are, for example, natural rubber such as gum Arabic or tragacanth gum; glucoxides such as saponin; cellulose derivatives such as methyl cellulose, carboxy cellulose, or hydroxymethyl cellulose; natural polymers such as lignosulfonic acid salts or shellac; anionic polymers such as polyacrylic acid salts, salts of styrene-acrylic acid copolymers, salts of vinylnaphthalene-maleic acid copolymers, sodium salts or phosphates of β-naphthalenesulfonic acid formalin condensation products; and nonionic polymers such as polyvinyl alcohol, polyvinylpyrrolidone, or polyethylene glycol.

Further, listed as examples of low molecular weight surface active agents are anionic surface active agents such as fatty acid salts, higher alcohol sulfuric acid ester salts, liquid fatty acid sulfuric acid ester salts or alkylaryl sulfonates; nonionic surface active agents such as polyoxyethylene alkyl ethers, sorbitan alkyl esters, or polyoxyethylene sorbitan alkyl esters. These compounds may be employed individually or in combinations of at least two types which are appropriately selected. The used amount is preferably in the range of 1-20% by mass with respect to the total ink mass.

Dispersing agents according to the present invention are preferably those having a carboxyl group, which are available as commercial products. Examples include polymer dispersing agents such as lignosulfonic acid snits (for example, VANILEX RN, produced by Nippon Paper Industries Co., Ltd.), copolymers of a-olefin and maleic anhydride (for example, FLORENE G-700, produced by KYOEISHA Chemical Co., Ltd.) or SUN EKISU (produced by Nippon Paper Industries Co., Ltd.). Of these, lignosulfonic acid salts are preferred in view of exhibiting extreme effect of the present invention.

The used amount of dispersing agents such as polymer dispersing agents according to the present invention is preferably 20-200% by mass with respect to the disperse dyes. When the amount of the dispersing agents is small, disperse dyes do not result in formation of minute particles, resulting in insufficient dispersion stability. On the other hand, the excessively large content of the dispersing agents is not preferred due to the following reasons. The formation of minute particles and dispersion stability are degraded, whereby ink viscosity increases. These dispersing agents may be employed individually or in combination.

### [Resin Binder]

The recording ink according to the present invention contains a resin binder. The resin binder preferably has an acid value of not less than 100 mg KOH/g and not more than 300 mg KOH/g, and a weight-average molecular weight of not less than 3,000 and not more than 30,000 and further has a solubility of 1% by mass or more based on water or alkali aqueous solution at 25° C., in view of penetration into the textile.

Of these, acryl copolymer resin is preferable because it exhibits less affection to ink ejection, whereby it can be added to the extent of content for inhibiting bleeding and contamination on a white background.

As acryl copolymer, preferably used is one in which hydrophobic monomer and hydrophilic monomer are copolymerized.

As hydrophobic monomers, listed are acrylic ester (such as n-butyl acrylate, 2-ethylhexyl acrylate, and 2-hydroxyethyl acrylate), methacrylic ester (such as ethyl methacrylate, butyl methacrylate, and glycidyl methacrylate), and styrene.

As hydrophilic monomers, listed are acrylic acid, methacrylic acid, and acrylamide. Ones having acid group such as acrylic acid is preferably employed in a neutralized state by base after polymerization.

As a molecular weight of the resin, an average molecular weight of from 3000 to 30000 preferably from 7000 to 20000 is employable.

Glass transition temperature Tg of the resin from −30° C. to 100° C., preferably from −10° C. to 80° C. is employable.

It is preferred that acid group come from acidic monomer of the resin is partially or completely neutralized by a base component. As a base for neutralization, bases containing alkali metal such as sodium hydroxide or potassium hydroxide; amines such as ammonia, alkanolamine, and alkylamine are employable.

In view of inhibiting bleeding, it is preferred to neutralize by using amines having boiling point of less than 200° C. Specifically, one neutralized by ammonia is preferred.

The content of resin binder in the recording ink is selected depending on the type or molecular weight of resin binder, and is preferably in the range of from 1% by mass to 20% by mass. In the case of adding less than 1% by mass, during evaporating of solvent after the recording ink is applied on the textile, increase of viscosity in the recording ink becomes small, thereby it may cause insufficient inhibition of bleeding.

In the case of adding more than 20% by mass, it may cause insufficient storage stability or ejection stability of the recording ink.

The resin binder of the present invention is utilized for achieving the function such as inhibition of bleeding, enhancement of the developed color, and prevention of contamination on a white background. A polymer dispersing agent may be employed as long as it satisfies this function. In this case, it is considered that a free polymer dispersing agent which is not absorbed on dye fulfills more function of the present invention. Therefore, in view of the object of the present invention, in order to allow the polymer dispersing agent to function by the resin binder, the excess amount of the polymer dispersing agent is preferably added over the adequate amount for dispersion stability. However, it may cause unstable in view of dispersion stability. Therefore, the resin binder is preferably added separately other than the polymer dispersing agent.

Further, as the recording ink in which the resin binder of the invention is added, preferred is ones which has property to increase its viscosity more by heating the recording ink during drying step. In this case, heating may be allowed at the portion where the recording ink is applied. The preferable temperature is in the range from 35° C. to 70° C. by a surface temperature at the portion of textile where the recording ink is applied. In the case of less than 35°C., it may cause insufficient inhibition of bleeding. In the case of more than 70° C., it may cause stretch or weaving of textile. Therefore, both are undesirable.

The recording ink is ejected to form image on the textile, then the disperse dye is fixed on the textile in the developing step. Consequently, the resin binder is preferably easy to eliminate in the washing step. When a lot of resin binders remain, texture becomes solid and undesirable. Therefore, the resin binder is preferable highly-soluble to washing water or detergent.

Further, the resin binder is preferable to exist stably in the recording ink and does not cause any precipitation under various storage circumstances or change of physical property such as viscosity.

Further more, even when the recording ink is dried in the vicinity of ejecting nozzle of the head, it is preferable to use the binder resin which can be eliminated easily such by being easily resolved or re-swelled or re-dispersed by the recording ink or the cleaning solution.

### [Water-Soluble Organic Solvent]

The recording ink of the present invention is characterized by using the water-soluble organic solvent. Specific examples of the preferable water-soluble organic solvent are the same as the water-soluble organic solvent contained in the functional ink.

Surface tension of the recording ink related to the present invention is preferably arranged so that the recording ink penetrates deeply into thick textile to obtain developed color without unevenness.

In above case, surface tension is preferably controlled in the range of not less than 20 mN/m and not more than 35 mN/m. In the case of less than 20 mN/m, it may cause increase of bleeding. In the case of more than 35 mN/m, it may cause insufficient effect on penetrating deeply and developing without unevenness.

As a method for arranging surface tension within above range, listed is a method for using a solvent having low surface tension or for incorporating an adequate amount of surface active agent. Specifically, it is preferable to arrange the surface tension by incorporating both the solvent having low surface tension and the surface active agent in an adequate amount.

As the solvent having low surface tension, it is preferable to contain a solvent having a surface tension of 25-40 mN/m by 10-30% by mass. More preferable embodiment is to contain a solvent having a surface tension of 25-35 mN/m by 10-30% by mass.

As the solvent having low surface tension of 25-40 mN/m, listed are water-soluble organic solvents such as glycol ether or 1,2-alkanediol.

The solvent may be employed singly by 10-30% by mass, or in combinations in total amount of thereof being 10-30% by mass.

The measurement methods of surface tension are described in common references of surface chemistry and colloidal chemistry. It is possible to employ the measurement methods described, for example, on pages 68-117 of Shin Jikken Kagaku Koza, Dai 18 Kan (Kaimen to Colloid), (Lecture on New Experimental Chemistry, volume 18 (Surface and Colloid)), edited by Nihon Kagaku Kai, published by Maruzen Co., Ltd. In practice, it is possible to determine surface tension employing a ring method (being the du Nouy method, and a platinum plate method (being the Wilhelmy method).

In the present invention, the surface tension is determined by using SURFACE TENSIOMETER CBVP A-3, produced by Kyowa Interface Science Co., Ltd.

Specific surface tension of each organic solvent is listed as follows (each surface tension value is represented by mN/m): as glycol ethers, ethyleneglycol monoethylether (28.2), ethyleneglycol monobutylether (27.4), diethyleneglycol monoethylether (31.8), diethyleneglycol monobutylether (33.6), triethyleneglycol monobutylether (32.1), propyleneglycol monopropylether (25.9), dipropyleneglycol monomethylether (28.8) and tripropyleneglycol monomethylether (30.0).

Further, as 1,2-alkanediols, listed are 1,2-butanediol, 1,2-pentanediol, 1,2-hexanediol (28.1) and 1,2-heptanediol.

In the recording ink of the present invention, various kinds of surface active agents may be employable. Specific example of the surface active agents is as same as the ones which are employable in the functional inks.

### [Other Additives]

In ink according to this invention, an antiseptic agent or an anti-mold agent may be added in ink to maintain long term storage stability of the ink. An anti-septic agent or an anti-mold agent includes, for example, aromatic halogen compounds (such as Preventol CMK), methylene dithiocyanato, halogen-containing sulfur nitride compounds and 1,2-benzisothiazoline-3-one (such as PROXEL GXL).

### <<Ink-Jet Textile Printing/Recording Process>>

In the ink-jet textile printing/recording process of the present invention, the functional ink is applied on the textile first. It is possible to apply the functional ink employing conventional application methods, known in the prior art, such as a roller coating method, a slit coater method, an extrusion coater method, or a spray method, other than ink jet method. In the present invention, from the viewpoint of being capable of applying the functional ink to optional portions of the textile, a method is preferred in which the functional ink is applied onto the textile by employing ink-jet method.

In the ink-jet textile printing/recording process of the present invention, subsequently, the recording ink is applied onto textiles by the ink-jet method. Specifically, provided is a member for applying the functional ink on the upstream of conveyance direction of textile, and a head for the recording ink on the downstream thereof, whereby textile printing is carried out sequentially by using the functional ink and then by the recording ink.

Further, in order to dry the functional ink to some extent after applying, it is preferable to provide a drying zone between the position of applying the functional ink and that of the recording ink.

The applying area of the functional ink can be selected as appropriate. The functional ink may be applied on the whole area of the textile, or on only specific area. As the functional ink functions to inhibit an image bleeding and to realize a high dense developed color, it may be applied only on the image area for applying the recording ink, whereby a consumption of the functional ink can be suppressed resulting in advantage for reducing a production cost. Further, it is undesirable to apply the functional ink on the white background because it may lead to a contamination of the white background. Preferable embodiment is to increase or decrease the amount of the applied functional ink according to the amount of the applied recording ink. In this case, preferred is to increase the amount of the applied functional ink according to increasing the amount of the applied recording ink.

Further, at the portion of the maximum density by the single color, preferred is to apply the sum of the amount of the water-soluble polymer by applying the functional ink and the amount of the resin binder by applying the recording ink on the textile is in the range of not less than 0.5 g/m² and not more than 5.0 g/m².

### [Color Development Process]

The color development process, as described herein, refers to a process in which dye in the recording ink is adsorbed and fixed to develop the original hue of dyes in an ink (also referred to as fixing treatment or color developing treatment), which is merely adhered onto the surface of textile after printing and is neither sufficiently adsorbed nor fixed. Employed as methods are steaming employing steam, dry heat baking, thermosol, HT steamer utilizing superheated steam, and HP steamer utilizing pressurized steam. These are suitably selected depending on printing components and inks. Further, printed textiles may be subjected to drying and a color development treatment corresponding to its intended use in such a manner that the heating treatment is performed immediately after printing or some time after printing. In the present invention, any of the above methods may be employed.

### [Washing Process]

A washing process is necessary after the heating treatment, because stability of color is deteriorated to lower the durability due to the remaining dye which has not participated in dyeing. Further, it is also necessary to remove water-soluble polymer in the functional ink or binder resin in the recording ink which have been applied on the textile. When they are left as they are, not only decrease of durability but also color change of the textile may be caused. Therefore, washing is indispensable corresponding to objects to be removed and the purpose. The method is selected according to a material to be printed, functional ink and recording ink, and the treatment is performed, for example in the case of polyester, by a mixed solution of caustic soda, a surface active agent and hydrosulfite. The method is practiced in a continuous mode with such as an open soaper or in a batch mode with such as a solution flow dyeing apparatus; and either method can be applied in this invention.

The washed textile is preferable to be dried with air or by use of such as dryer, heat roll or iron, after having been squeezed or dehydrated.

### [Textiles]

Components which constitute textiles employed in the ink-jet textile printing/recording process of the present invention are not particularly limited as long as they incorporate fibers capable of being dyed employing disperse dyes. Of these, preferred are those incorporating polyester, acetate or triacetate fibers. Of these, particularly preferred are textiles incorporating polyester fibers. Textiles may be employed in any form in which fibers are woven, or knitted, or in the form of nonwoven textile. Further, it is suitable that textiles usable in the present invention are composed of 100% of fibers capable of being dyed with disperse dyes, but it is also possible to use blended textiles with rayon, cotton, polyurethane, acryl, nylon, wool and silk or blended nonwoven textile. Further, the thickness of threads constituting the above textiles is preferably in the range of 10-100 d.

### EXAMPLES

The present invention will now be specifically described with reference to examples, but the present invention is not limited thereto. Further, “parts” and “%” which are used in the examples are “parts by mass” and “% by mass”, respectively, unless otherwise specified.

### Example 1

### [Preparation of Functional Ink]

Based on the formula shown in Table 1, functional inks were prepared, followed by being subjected to filtration employing a membrane filter of 3 μm and subjected to degassing treatments. Degassing was performed in such a manner that each of the prepared inks was allowed to pass through a gas permeable hollow fiber membrane and by reducing pressure on the exterior surface of the hollow fiber membrane, employing a tap aspirator, gases dissolved in the ink were removed. Further, after degassing, the resulting ink was subjected to vacuum packing to prevent it from mixing with ambient air. Used compounds were as followings:

PVP (K15), PVP (K30): Polyvinyl pyrrolidone (Tokyo Chemical Industry Co., Ltd.)

PEG (Mw:600): Polyethylene glycol (Kanto Chemical Co., Inc.)

Pluronic F88: Ethylene oxide-propylene oxide copolymer (ADEKA CORPORATION)

SC-E450: Polyethyleneoxide adduct of glycerin (Sakamoto Yakuhin Kogyo Co., Ltd.)

Glycerin (EO) 450: Ethyleneoxide adduct of glycerin (Nitto Boseki Co., Ltd.)

Johncryl 70J: Acryl acid type copolymer neutralized by ammoia (BASF)

Olfin E1010: Acetylene glycol type surface active agent (Shin-Etsu Chemical Co., Ltd.)

KF351A: Silicone surface active agent (Shin-Etsu Chemical Co., Ltd.)

DEGBE: Diethyleneglycol monobutylether

TABLE 1

| | Function Ink No. | | | | | | | | | | | | | |
|---|---|---|---|---|---|---|---|---|---|---|---|---|---|---|
| | F-1 | F-2 | F-3 | F-4 | F-5 | F-6 | F-7 | F-8 | F-9 | F-10 | F-11 | F-12 | F-13 | F-14 |
| PVP (K15) | 5 | | | | | | | | | 5 | 5 | | | |
| PVP (K30) | | 5 | | | | | | | | | | | | 4 |
| PEG (MW600) | | | 5 | | | | | | | | | | | |
| Pluronic F88 | | | | 5 | | | | | | | | | | |
| SC-E450 | | | | | 10 | | | | | | | 10 | | |
| Glycerin (EO) | | | | | | 10 | | | | | | | | |
| 450 | | | | | | | | | | | | | | |
| Johncryl 70J | | | | | | | 5 | | | | | | | |
| Polyvinyl | | | | | | | | 5 | | | | | | |
| alcohol | | | | | | | | | | | | | | |
| Carboxymethyl | | | | | | | | | 5 | | | | | |
| cellulose | | | | | | | | | | | | | | |
| OlfinE1010 | 0.2 | 0.2 | 0.2 | 0.2 | 0.2 | 0.2 | 0.2 | 0.2 | 0.2 | 0.2 | 0.2 | 0.2 | 0.2 | 0.2 |
| KF351A | 0.1 | 0.1 | 0.1 | 0.1 | 0.1 | 0.1 | 0.1 | 0.1 | 0.1 | 0.1 | 0.1 | 0.1 | 0.1 | 0.1 |
| Ethylene glycol | 20 | 20 | 20 | 20 | 20 | 20 | 20 | 20 | 20 | 20 | 25 | 25 | 20 | |
| Glycerin | 5 | 5 | 5 | 5 | 5 | 5 | 5 | 5 | 5 | 5 | 5 | 5 | 5 | |
| DEGBE | 5 | 5 | 5 | 5 | 5 | 5 | 5 | 5 | 5 | | | | 5 | |
| 1,2-Hexanediol | | | | | | | | | | 5 | | | | |
| Ion-exchanged | Balance | Balance | Balance | Balance | Balance | Balance | Balance | Balance | Balance | Balance | Balance | Balance | Balance | Balance |
| water | | | | | | | | | | | | | | |

### [Preparation of Dispersions]

After successively mixing additives described below, the resulting mixture was dispersed employing a sand grinder, whereby a disperse dye dispersion was prepared. Dispersion was terminated when the average diameter of dispersed disperse dye particles reached 200 nm. Subsequently, the pH was controlled to 8.0 by adding the necessary amount of sulfuric acid or sodium hydroxide.

| | |
|---|---|
| Disperse dye (listed in Tables 3 to 5) | 20 parts |
| Glycerin | 10 parts |
| Dispersing Agent (listed in Tables 3 to 5) | 10 parts |
| Sulfuric acid or sodium hydroxide | control to pH = 8.0 |
| Ion-exchanged water | balance |

Compounds used are as followings:

Y dye: C.I. Disperse Yellow 149

M dye: C.I. Disperse Red 302

C dye: C.I. Disperse Blue 60

VANILEX RN (dispersant): Sodium lignin sulfonate produced by Nippon Paper Group, Inc.)

FLORENE G-700 (dispersant): olefin-maleic acid copolymer (produced by KYOEISHA CHNICAL CO., LTD.)

DEMOL N (dispersant): sodium β-naphthalene sulfonate-formaline condensate (produced by Kao Corporation)

### [Synthesis of Resin Binder]

### <<Synthesis of Polymer Resin>>

### [Synthesis of Polymer Resin R-1]

Into a flask equipped with dropping funnels, a nitrogen gas introducing tube, a reflux condenser, a thermometer, and an agitator, 50 g of methylethyl ketone was charged, and the temperature was increased to 75° C. while bubbling with nitrogen. Subsequently, as shown in Table 1, a mixture of 85 g of butylmethacrylate, 15 of acrylic acid, and 500 mg of initiator AIBN (azobisisobutylonitrile) were added by dropping over a 3 hour period through the dropping funnels and at the same time. Subsequently, the heat-reflux was continued for another 6 hours. After open cooling, by heating under reduced pressure, methylethyl ketone was distilled away, whereby polymer residue was obtained. Next, above polymer residue was dissolved in 450 ml of ion-exchanged water in which mol equivalent of dimetylaminoethanol 1.05 times acrylic acid added as monomer was dissolved. Finally, by controlling by ion-exchanged water, aqueous solution was obtained which contained 20% of polymer resin R-1 in terms of solid.

The weight average molecular weight of polymer resin R-1 obtained as above is measured by the following of gel permeation chromatography to be 11000.

The following describes the measurement conditions:

Solvent: methylene chloride

Column: Shodex K506, K805 and K803G (Three pieces manufactured by Showa Denko K.K. were connected for use)

Column temperature: 25° C.

Sample concentration: 0.1% by mass

Detector: RI Model 504 (manufactured by GL Science Co., Ltd.)

Pump: L6000 (manufactured by Hitachi Limited)

Flow rate: 1.0 ml/min.

Calibration curve: The calibration curve using 13 samples of the standard polystyrene STK standard polystyrene (manufactured by Toso Co., Ltd.) was employed, wherein Mw=1000000 through 500. These 13 samples were placed at an approximately equally spaced interval.

Further, acid value of polymer resin was evaluated by employing an automatic titration apparatus COM-2500WSC12, manufactured by Hiranuma Sangyo Co., Ltd, employing a titration liquid: 0.1 mol/L potassium hydroxide (ethanol), dispensing liquid: acetone, glass electrode: GE-101E, and reference electrode: RE-201 to be 115 mg KOH/g.

### [Synthesis of Polymer Resins R-2 to R-9]

Aqueous solution of polymer resins R-2 to R-9 of 20% in teens of solid were obtained in the same manner as synthesis of polymer resin R-1, except for changing monomer composition as shown in Table 2.

In Table 2, weight average molecular weight and acid value determined according ₜo above method were listed.

TABLE 2

| | R-1 | R-2 | R-3 | R-4 | R-5 | R-6 | R-7 | R-8 | R-9 |
|---|---|---|---|---|---|---|---|---|---|
| n-Butyl | 85 | 55 | 45 | 40 | 90 | 55 | 55 | 55 | 55 |
| methacrylate | | | | | | | | | |
| Styrene | | 20 | 20 | 20 | | 20 | 20 | 20 | 20 |
| Acrylic acid | 15 | 25 | 35 | 40 | 10 | 25 | 25 | 25 | 25 |
| Weight-average | 11000 | 10000 | 9000 | 8000 | 9000 | 2500 | 4000 | 28000 | 35000 |
| molecular weight | | | | | | | | | |
| Acid value | 115 | 197 | 278 | 314 | 82 | 203 | 198 | 202 | 195 |
| (mgKOH/g) | | | | | | | | | |

### [Preparation of Recording Inks]

By employing above Dispersions, recording inks were prepared based on the formula shown in Tables 3 to 5. Subsequently, in the same manner as for preparation of function ink, filtration and degassing treatment were carried out.

TABLE 3

| | Yellow Ink No. | | | | | | | | | | | | | |
|---|---|---|---|---|---|---|---|---|---|---|---|---|---|---|
| | Y-1 | Y-2 | Y-3 | Y-4 | Y-5 | Y-6 | Y-7 | Y-8 | Y-9 | Y-10 | Y-11 | Y-12 | Y-13 | Y-14 |
| Y Dye | 2 | 2 | 2 | 2 | 2 | 2 | 2 | 2 | 2 | 2 | 2 | 2 | 2 | 2 |
| VANILEX RN | 1 | 1 | 1 | 1 | 1 | 1 | 1 | 1 | 1 | 1 | 1 | | | 1 |
| FLORENE | | | | | | | | | | | | 1 | | |
| G-700 | | | | | | | | | | | | | | |
| DEMOL N | | | | | | | | | | | | | 1 | |
| R-1 | 8 | | | | | | | | | | 8 | 8 | 8 | |
| R-2 | | 8 | | | | | | | | | | | | |
| R-3 | | | 8 | | | | | | | | | | | |
| R-4 | | | | 8 | | | | | | | | | | |
| R-5 | | | | | 8 | | | | | | | | | |
| R-6 | | | | | | 8 | | | | | | | | |
| R-7 | | | | | | | 8 | | | | | | | |
| R-8 | | | | | | | | 8 | | | | | | |
| R-9 | | | | | | | | | 8 | | | | | |
| PVP (K30) | | | | | | | | | | 8 | | | | |
| OlfinE1010 | 0.2 | 0.2 | 0.2 | 0.2 | 0.2 | 0.2 | 0.2 | 0.2 | 0.2 | 0.2 | 0.2 | 0.2 | 0.2 | 0.2 |
| KF351A | 0.1 | 0.1 | 0.1 | 0.1 | 0.1 | 0.1 | 0.1 | 0.1 | 0.1 | 0.1 | 0.1 | 0.1 | 0.1 | 0.1 |
| Ethylene glycol | 20 | 20 | 20 | 20 | 20 | 20 | 20 | 20 | 20 | 20 | 20 | 20 | 20 | 20 |
| Glycerin | 10 | 10 | 10 | 10 | 10 | 10 | 10 | 10 | 10 | 10 | 5 | 10 | 10 | 10 |
| DEGBE | | | | | | | | | | | 5 | | | |
| Ion-exchanged | Balance | Balance | Balance | Balance | Balance | Balance | Balance | Balance | Balance | Balance | Balance | Balance | Balance | Balance |
| water | | | | | | | | | | | | | | |

TABLE 4

| | Magenta Ink No. | | | | | | | | | | | | | |
|---|---|---|---|---|---|---|---|---|---|---|---|---|---|---|
| | M-1 | M-2 | M-3 | M-4 | M-5 | M-6 | M-7 | M-8 | M-9 | M-10 | M-11 | M-12 | M-13 | M-14 |
| M Dye | 6 | 6 | 6 | 6 | 6 | 6 | 6 | 6 | 6 | 6 | 6 | 6 | 6 | 6 |
| VANILEX RN | 3 | 3 | 3 | 3 | 3 | 3 | 3 | 3 | 3 | 3 | 3 | | | 3 |
| FLORENE | | | | | | | | | | | | 3 | | |
| G-700 | | | | | | | | | | | | | | |
| DEMOL N | | | | | | | | | | | | | 3 | |
| R-1 | 8 | | | | | | | | | | 8 | 8 | 8 | |
| R-2 | | 8 | | | | | | | | | | | | |
| R-3 | | | 8 | | | | | | | | | | | |
| R-4 | | | | 8 | | | | | | | | | | |
| R-5 | | | | | 8 | | | | | | | | | |
| R-6 | | | | | | 8 | | | | | | | | |
| R-7 | | | | | | | 8 | | | | | | | |
| R-8 | | | | | | | | 8 | | | | | | |
| R-9 | | | | | | | | | 8 | | | | | |
| PVP (K30) | | | | | | | | | | 8 | | | | |
| OlfinE1010 | 0.2 | 0.2 | 0.2 | 0.2 | 0.2 | 0.2 | 0.2 | 0.2 | 0.2 | 0.2 | 0.2 | 0.2 | 0.2 | 0.2 |
| KF351A | 0.1 | 0.1 | 0.1 | 0.1 | 0.1 | 0.1 | 0.1 | 0.1 | 0.1 | 0.1 | 0.1 | 0.1 | 0.1 | 0.1 |
| Ethylene glycol | 20 | 20 | 20 | 20 | 20 | 20 | 20 | 20 | 20 | 20 | 20 | 20 | 20 | 20 |
| Glycerin | 10 | 10 | 10 | 10 | 10 | 10 | 10 | 10 | 10 | 10 | 5 | 10 | 10 | 10 |
| DEGBE | | | | | | | | | | | 5 | | | |
| Ion-exchanged | Balance | Balance | Balance | Balance | Balance | Balance | Balance | Balance | Balance | Balance | Balance | Balance | Balance | Balance |
| water | | | | | | | | | | | | | | |

TABLE 5

| | Cyan Ink No. | | | | | | | | | | | | | |
|---|---|---|---|---|---|---|---|---|---|---|---|---|---|---|
| | C-1 | C-2 | C-3 | C-4 | C-5 | C-6 | C-7 | C-8 | C-9 | C-10 | C-11 | C-12 | C-13 | C-14 |
| C Dye | 10 | 10 | 10 | 10 | 10 | 10 | 10 | 10 | 10 | 10 | 10 | 10 | 10 | 10 |
| VANILEX RN | 5 | 5 | 5 | 5 | 5 | 5 | 5 | 5 | 5 | 5 | 5 | | | 5 |
| FLORENE | | | | | | | | | | | | 5 | | |
| G-700 | | | | | | | | | | | | | | |
| DEMOL N | | | | | | | | | | | | | 5 | |
| R-1 | 8 | | | | | | | | | | 8 | 8 | 8 | |
| R-2 | | 8 | | | | | | | | | | | | |
| R-3 | | | 8 | | | | | | | | | | | |
| R-4 | | | | 8 | | | | | | | | | | |
| R-5 | | | | | 8 | | | | | | | | | |
| R-6 | | | | | | 8 | | | | | | | | |
| R-7 | | | | | | | 8 | | | | | | | |
| R-8 | | | | | | | | 8 | | | | | | |
| R-9 | | | | | | | | | 8 | | | | | |
| PVP (K30) | | | | | | | | | | 8 | | | | |
| OlfinE1010 | 0.2 | 0.2 | 0.2 | 0.2 | 0.2 | 0.2 | 0.2 | 0.2 | 0.2 | 0.2 | 0.2 | 0.2 | 0.2 | 0.2 |
| KF351A | 0.1 | 0.1 | 0.1 | 0.1 | 0.1 | 0.1 | 0.1 | 0.1 | 0.1 | 0.1 | 0.1 | 0.1 | 0.1 | 0.1 |
| Ethylene glycol | 20 | 20 | 20 | 20 | 20 | 20 | 20 | 20 | 20 | 20 | 20 | 20 | 20 | 20 |
| Glycerin | 10 | 10 | 10 | 10 | 10 | 10 | 10 | 10 | 10 | 10 | 5 | 10 | 10 | 10 |
| DEGBE | | | | | | | | | | | 5 | | | |
| Ion-exchanged | Balance | Balance | Balance | Balance | Balance | Balance | Balance | Balance | Balance | Balance | Balance | Balance | Balance | Balance |
| water | | | | | | | | | | | | | | |

### [Preparation of Print Image]

The functional ink shown in Table 1 was introduced into two heads on the first head cartridge. Three kinds of recording inks shown in Tables 3 to 5 were introduced into three heads on the second head cartridge.

As textile, employed was untreated polyester.

On the whole area of conveyed textile, the functional ink was uniformly applied from each of two heads on the first head cartridge in an amount of 9 ml/m². Then, the recording inks were applied from three heads on the second head cartridge. Print images were prepared by printing 10 cm×10 cm solid image in single color of Y, M and C, 10 cm×10 cm solid image in secondary color of B, G, and R, 10 cm×10 cm solid image in blend color of Y, M, and C. Solid image in single color of Y, M, and C each was printed by 100% Duty and it corresponds to the ink application amount of about 11 ml/m². As the same manner, the ink application amount of solid image in secondary color of B, G, and R was 22 ml/m², and solid image in blend color of Y, M, and C was 33 ml/m².

The functional ink applied on the textile was subjected to dry by employing H1 heater and H2 heater. The recording ink applied on the textile was subjected to dry by employing H3 heater. Heating temperature was controlled to be 40° C. to 50° C. at the surface of the textile.

Each of the evaluation samples, prepared as above, was subjected to a heat color development process at about 200° C. for one minute, employing a heating roller. Washing was performed by employing the washing solution prepared by dissolving HIGH CLEANER CA-10Y, produced by Tokai Seiyu Co. in an amount of 2 g/liter in city water, and then dried.

### [Evaluation of Print Image]

### (Evaluation of Bleeding)

Bleeding in the printed image was visually observed and evaluated based on the following criteria. Results were listed in Table 6.

5: No bleeding was observed.

4: Slight bleeding was observed at the border of the solid image in blend color of Y, M, and C (33 ml/m²).

3: Apparent bleeding was observed at the border of the solid image in blend color of Y, M, and C (33 ml/m²), however no bleeding was observed on solid image in secondary color of B, G, and R (22 ml/m²).

2: Apparent bleeding was observed at the border of the solid image in secondary color of B, G, and R (22 ml/m²).

1: Apparent bleeding was observed at the border of the solid image in single color of Y, M, and C (11 ml/m²).

### (Evaluation of Developed Color)

All of density of Y, M, C, B, G, R, and blend color of YMC was determined. As the reference, the following pretreatment solution was prepared and applied on the textile by employing mangle, followed by drying, to prepare the reference textile separately. Based on the sum of developed density of the print on the reference textile being ranked as 5, the sum of developed density of the print on each textile sample was ranked from 5 (high density) to 1 (low density) by relative evaluation. Results were listed in Table 6.

Pretreatment Solution for Reference Textile

| | |
|---|---|
| Ammonium sulfate | 3% by mass |
| Polyvinylpyrrolidone | 10% by mass |
| Balance | Water |

### (Evaluation of Texture)

The textures of above textiles were evaluated by feeling of the solid image of blend color of YMC. Evaluation criteria were shown as followings and results were listed in Table 6.

3: No change of texture was noted comparing to before printing.

2: Slight stiffiness was noted comparing to before printing.

1: The definite stiffiness was felt and the texture was lost.

### (Evaluation of Contamination Resistance)

Contamination resistance was evaluated by visually observation of the contamination state of non-printed white portion in washing and drying steps after developing printed image and evaluated based on the following criteria. Results were listed in Table 6.

5: No contamination was observed.

4: Slight contamination was observed, however disappeared after strengthening washing.

3. Contamination was observed, and remained slightly even after strengthening washing.

2. Contamination was observed, and remained even after strengthening washing.

1. Extreme contamination remained even after strengthening washing, and was practically problematic quality.

TABLE 6

| Print | Functional | | | | Bleeding | Developed | | Contamination | |
|---|---|---|---|---|---|---|---|---|---|
| No. | Ink | Recording Ink Set | | | Resistance | Color | Texture | resistance | Remarks |
| 1 | F-1 | Y-1 | M-1 | C-1 | 5 | 5 | 3 | 5 | Inv. |
| 2 | F-2 | Y-1 | M-1 | C-1 | 5 | 5 | 3 | 5 | Inv. |
| 3 | F-3 | Y-1 | M-1 | C-1 | 4 | 5 | 2 | 4 | Inv. |
| 4 | F-4 | Y-1 | M-1 | C-1 | 5 | 5 | 3 | 5 | Inv. |
| 5 | F-5 | Y-1 | M-1 | C-1 | 4 | 4 | 3 | 4 | Inv. |
| 6 | F-6 | Y-1 | M-1 | C-1 | 4 | 4 | 3 | 4 | Inv. |
| 7 | F-7 | Y-1 | M-1 | C-1 | 4 | 4 | 3 | 4 | Inv. |
| 8 | F-8 | Y-1 | M-1 | C-1 | 3 | 4 | 3 | 3 | Inv. |
| 9 | F-9 | Y-1 | M-1 | C-1 | 3 | 4 | 3 | 3 | Inv. |
| 10 | F-10 | Y-1 | M-1 | C-1 | 5 | 5 | 3 | 5 | Inv. |
| 11 | F-11 | Y-1 | M-1 | C-1 | 4 | 5 | 3 | 4 | Inv. |
| 12 | F-12 | Y-1 | M-1 | C-1 | 3 | 4 | 3 | 3 | Inv. |
| 13 | F-13 | Y-1 | M-1 | C-1 | 1 | 2 | 3 | 1 | Comp. |
| 14 | F-14 | Y-1 | M-1 | C-1 | 2 | 3 | 3 | 2 | Comp. |
| 15 | F-1 | Y-2 | M-2 | C-2 | 5 | 5 | 3 | 5 | Inv. |
| 16 | F-1 | Y-3 | M-3 | C-3 | 5 | 5 | 3 | 5 | Inv. |
| 17 | F-1 | Y-4 | M-4 | C-4 | 4 | 5 | 3 | 4 | Inv. |
| 18 | F-1 | Y-5 | M-5 | C-5 | 5 | 3 | 2 | 5 | Inv. |
| 19 | F-1 | Y-6 | M-6 | C-6 | 4 | 5 | 3 | 4 | Inv. |
| 20 | F-1 | Y-7 | M-7 | C-7 | 5 | 5 | 3 | 5 | Inv. |
| 21 | F-1 | Y-8 | M-8 | C-8 | 5 | 5 | 3 | 5 | Inv. |
| 22 | F-1 | Y-9 | M-9 | C-9 | 5 | 3 | 2 | 5 | Inv. |
| 23 | F-1 | Y-10 | M-10 | C-10 | 4 | 4 | 3 | 4 | Inv. |
| 24 | F-1 | Y-11 | M-11 | C-11 | 5 | 5 | 3 | 5 | Inv. |
| 25 | F-1 | Y-12 | M-12 | C-12 | 4 | 4 | 3 | 4 | Inv. |
| 26 | F-1 | Y-13 | M-13 | C-13 | 4 | 4 | 3 | 3 | Inv. |
| 27 | F-1 | Y-14 | M-14 | C-14 | 1 | 1 | 3 | 1 | Comp. |

Inv.: Inventive Example,
Comp.: Comparative Example

From Table 6, it is found that the effect of the present invention can be produced when the functional ink is combined with the recording ink each having the constitution of the present invention.

By comparing Print Nos. 1-9, it is found that as the water-soluble polymer in the functional ink, it is preferable polyvinyl pyrrolidone, polyethylene glycol, ethylene oxide-propylene oxide copolymer, polyethylene oxide adduct of glycerin, polypropylene adduct of glycerin, polyethylene oxide adduct of diglycerin, polypropylene adduct of diglycerin, and acrylic resin.

By comparing Print Nos. 15-23, it is found that the effect of the present invention is remarkable when the resin binder contained in the recording ink has carboxyl group, an acid value of not less than 100 mg KOH/g and not more than 300 mg KOH/g, and a weight-average molecular weight of not less than 3,000 and not more than 30,000.

By comparing Print Nos. 1, 5, 10, 11 and 12, it is found that the effect of the present invention is remarkable when the functional ink contains glycol ethers or 1,2-alkanediols.

By comparing Print Nos. 1, 25 and 26, it is found that the effect of the present invention is remarkable when the dispersing agents are lignosulfonic acid salts.

### Example 2

In the preparation of the functional ink F-1 and the recording inks Y-1, M-1, and C-1 in Example 1, the same evaluations as Example 1 were earned out under the following conditions. Namely, the functional ink was printed from two heads of the first head carriage in total amount of 18 ml/m², and the recording inks Y, M, and C were printed from heads of the second head carriage in each amount of 11 ml/m² as 10 cm×10 cm solid image in single color. Under above conditions, the amount of the water-soluble polymer in the functional ink and each resin binder in the recording inks Y, M, C in Example 1 were changed so that applied amount of the water-soluble polymer and the resin binder at a portion of the textile where printed areas with the maximum density were changed as shown in Table 7. Results were listed in Table 7.

TABLE 7

| | Applied amount of | | | | | | |
|---|---|---|---|---|---|---|---|
| | Water-soluble | Applied amount of | Total | | | | |
| | polymer in | Resin binder in | applied | | | | |
| Print | Functional ink | Recording ink | amount | Bleeding | Developed | | Contamination |
| No. | (g/m²) | (g/m²) | (g/m²) | Resistance | Color | Texture | Resistance |
| 31 | 0.1 | 0.1 | 0.2 | 3 | 3 | 3 | 3 |
| 32 | 0.2 | 0.2 | 0.4 | 3 | 3 | 3 | 3 |
| 33 | 0.3 | 0.2 | 0.5 | 4 | 5 | 3 | 4 |
| 34 | 1.0 | 0.2 | 1.2 | 5 | 5 | 3 | 5 |
| 35 | 2.0 | 0.2 | 2.2 | 5 | 5 | 3 | 5 |
| 36 | 0.2 | 0.3 | 0.5 | 4 | 5 | 3 | 4 |
| 37 | 0.2 | 1.0 | 1.2 | 5 | 5 | 3 | 5 |
| 38 | 0.2 | 2.0 | 2.2 | 5 | 5 | 3 | 5 |
| 39 | 2.0 | 2.0 | 4.0 | 5 | 5 | 3 | 5 |
| 40 | 2.5 | 2.5 | 5.0 | 5 | 4 | 3 | 5 |
| 41 | 3.0 | 3.0 | 6.0 | 5 | 3 | 2 | 5 |

The results described in Table 7 clearly show that it was found that the effect of the present invention is remarkable in balancing of each performances when a sum of an applied amount of the water-soluble polymer and an amount of the resin binder which is applied on the textile by the functional ink and the recording ink, respectively, is not less than 0.5 g/m² and not more than 5.0 g/m².

### Example 3

In Example 1, when a surface temperature at the portion where the recording ink was applied was changed by controlling the temperature of heater H3, it was found that the effect of inhibiting bleeding was remarkable in the range of from 35° C. to 70° C. Further, by comparing the case of switching off heater H-2 between steps of applying the functional ink and the recording ink, it was found that the effect of inhibiting bleeding was remarkable in the case of heating for drying.

### EXPLANATION OF TILE SYMBOLS

1 The first head

2 The second head

3 Heater H-1

4 Heater H-2

5 Heater H-3

6 Roller

7 Roller

1. An ink jet textile printing/recording process comprising steps of:
applying a functional ink by an ink jet system to at least a portion of a textile where printed area with the maximum density is to be formed, and followed by
applying a recording ink to the textile by an ink-jet system,
wherein the functional ink comprises a water-soluble polymer and a water-soluble organic solvent, and
the recording ink comprises a disperse dye, a binder resin, and a water-soluble organic solvent.

2. The ink jet textile printing/recording process of claim 1, wherein
the water-soluble polymer is at least one selected from a group of polyvinyl pyrrolidone, polyethylene glycol, ethylene oxide-propylene oxide copolymer, polyethylene oxide adduct of glycerin, polypropylene adduct of glycerin, polyethylene oxide adduct of diglycerin, polypropylene adduct of diglycerin, and acrylic resin.

3. The ink jet textile printing/recording process of claim 1, wherein
the water-soluble polymer is at least one selected from a group of polyvinyl pyrrolidone and ethylene oxide-propylene oxide copolymer.

4. The ink jet textile printing/recording process of claim 1, wherein
the binder resin has
a carboxyl group,
an acid value of the binder resin of not less than 100 mg KOH/g and not more than 300 mg KOH/g, and
a weight-average molecular weight of not less than 3,000 and not more than 30,000.

5. The ink jet textile printing/recording process of claim 1, wherein
the textile is not treated with a pre-treatment, and
a sum of an amount of the water-soluble polymer applied by the functional ink and an amount of the resin binder applied by the recording ink, is not less than 0.5 g/m² and not more than 5.0 g/m² at a portion of the textile where printed area with the maximum density is to be formed by single color.

6. The ink jet textile printing/recording process of claim 1, wherein
at least one of the water-soluble organic solvent in the functional ink is glycol ethers or 1,2-alkane diols.

7. The ink jet textile printing/recording process of claim 1, wherein
the disperse dye in the recording ink is dispersed by a lignin sulfonates.

8. The ink jet textile printing/recording process of claim 1,
comprising a step of heating the textile to a surface temperature in the range of 35° C. to 70° C. at a portion where the recording ink is applied.

9. The ink jet textile printing/recording process of claim 1,
comprising a step of drying between the step of applying the functional ink and the step of applying the recording ink.
